(19) United States
(12) Patent Application Publication
(10) Pub. No.: US 2014/0368924 A1
(43) Pub. Date: Dec. 18, 2014

(54) OPTICAL MODULE AND METHOD FOR MANUFACTURING THE SAME

(71) Applicants: AUTONETWORKS TECHNOLOGIES, LTD., Yokkaichi (JP); SUMITOMO WIRING SYSTEMS, LTD., Yokkaichi (JP); SUMITOMO ELECTRIC INDUSTRIES, LTD., Osaka (JP)

(72) Inventor: Hiroshi TATEISHI, Yokkaichi (JP)

(21) Appl. No.: 14/304,122

(22) Filed: Jun. 13, 2014

(30) Foreign Application Priority Data
Jun. 18, 2013 (JP) 2013-127286

(51) Int. Cl. G02B 27/30; G02B 7/00

(52) U.S. Cl. CPC G02B 27/30; G02B 7/003; G02B 3/00
USPC 359/641; 29/428

(57) ABSTRACT

An optical module that facilitates positioning includes an optical device and a light transmitting member having a fitting portion into which a counterpart optical member is fitted and having a lens portion that collimates light of a first wavelength emitted from the optical device or that converges parallel light of the first wavelength emitted from the counterpart optical member into converged light to be incident on the optical device. The light transmitting member is formed such that a position of a leading end surface of the fitting portion coincides with a position of an imaging plane in a direction of the optical axis. The imaging plane is a plane on which irradiated visible light is imaged. The visible light has a second wavelength that is lower than the first wavelength and is transmitted through the lens portion and reflected from the optical device onto the imaging plane.

### CROSS-REFERENCE TO RELATED APPLICATION

This application claims the priority to Japanese Application No. JP2013-127286 filed Jun. 18, 2013, the entire contents of which is incorporated by reference.

### BACKGROUND

The present application relates to an optical module including an optical device and a light transmitting member made of a material that transmits light, and a method for manufacturing the optical module.

To manufacture such an optical module, it is important to accurately position the optical device and the light transmitting member. According to the disclosure of JP 2009-271457A, positioning of the optical device and the light transmitting member is performed by observing light transmitted through a lens using a microscope.

In such an optical module, a lens collimates light (light of a wavelength for use in communication) to be emitted or converges parallel light emitted from a counterpart optical member. When light propagating through space is parallel light, the optical module reduces the coupling loss that occurs when the optical module and the counterpart optical member are offset from each other in an axial direction. In other words, the optical module is resistant to offsets in the axial direction.

However, when light of a wavelength for use in communication is used, the light propagating through space is collimated, and the light reflected from the optical device is not imaged. Therefore, positioning of the optical device and the light transmitting member cannot be performed with the optical module.

### SUMMARY

It is thus an object of the invention to make it possible to easily position an optical device and a light transmitting member of an optical module from which parallel light is emitted or on which parallel light is incident.

In order to address the above-described problem, an optical module according to some aspects of the invention includes an optical device and a light transmitting member made of a light transmissive material. The light transmitting member has a fitting portion into which a counterpart optical member is fitted. The light transmitting member also has a lens portion that collimates light of a first wavelength emitted from the optical device or that converges parallel light of the first wavelength emitted from the counterpart optical member into converged light to be incident on the optical device. The light transmitting member is formed in such a shape that when visible light of a second wavelength that is lower than the first wavelength is irradiated, the position of an imaging plane on which the light of the second wavelength transmitted through the lens portion and reflected by the optical device is imaged coincides with the position of a leading end surface of the fitting portion in an optical axis direction.

The leading end surface of the fitting portion may have a ring shape, and the center of the ring shape may be located on the optical axis.

A method for manufacturing the optical module according to some aspects of the invention includes a positioning step that includes irradiating the optical device and the light transmitting member with light of the second wavelength, and positioning the optical device relative to the light transmitting member such that the optical device is located in a position at which relative positions of the imaging plane and the leading end surface of the fitting portion satisfy a predetermined positional relationship, by moving at least one of the optical device and the light transmitting member while observing the relative positions of the imaging plane and the leading end surface of the fitting portion using an imaging apparatus.

Also, another method for manufacturing the optical module according to some aspects of the invention includes a positioning step that includes irradiating the optical device and the light transmitting member with light of the second wavelength, and positioning the optical device relative to the light transmitting member such that the leading end surface of the fitting portion, the leading end surface having the ring shape, and the imaging plane are concentric with each other, by moving at least one of the optical device and the light transmitting member while observing relative positions of the imaging plane and the leading end surface of the fitting portion using an imaging apparatus.

In the optical module according to the above aspects of the invention, when visible light of the second wavelength that is lower than the first wavelength is irradiated, the position of the imaging plane, on which the light of the second wavelength reflected by the optical device is imaged, coincides with the position of the leading end surface of the fitting portion in the optical axis direction. In other words, when the light of the second wavelength is irradiated, the imaging plane of the light reflected from the optical device is coplanar with the leading end surface of the fitting portion. Therefore, positioning of the optical device and the light transmitting member can be performed by positioning the imaging plane and the leading end surface of the fitting portion relative to each other.

When the leading end surface of the fitting portion has a ring shape, positioning of the optical device and the light transmitting member is finished by making the ring-shaped leading end surface and the imaging plane concentric with each other.

### BRIEF DESCRIPTION OF THE DRAWINGS

FIG. 1 is a cross-sectional view of an optical module according to an embodiment of the invention;

FIG. 2 shows an example of an alignment system for use in an alignment step of a method for manufacturing the optical module according to the embodiment of the invention;

FIG. 3 schematically shows an image that is displayed on a monitor before positioning of an optical device and a light transmitting member in the alignment step;

FIG. 4 schematically shows a state in which a camera and a sleeve member are positioned relative to each other;

FIG. 5 schematically shows a state in which the camera and the optical device (optical device active layer) are positioned relative to each other;

FIG. 6 is a cross-sectional view showing dimensions of an optical module according to a first example;

FIG. 7 is a cross-sectional view showing dimensions of an optical module according to a second example.

### DETAILED DESCRIPTION OF EMBODIMENTS

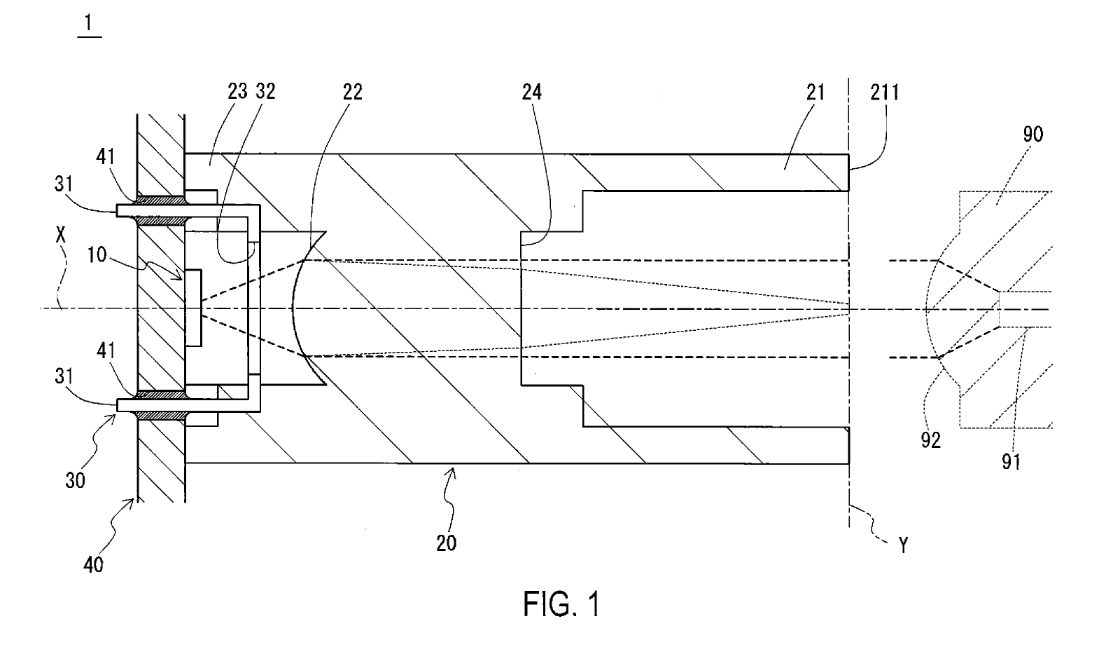

Hereinafter, an embodiment of the invention will be described in detail with reference to the drawings. An optical module 1 according to an embodiment of the invention shown in FIG. 1 includes an optical device 10 and a light transmitting member 20. The optical device 10 is a photoelectric conversion device that has at least one of the function of converting an electric signal into an optical signal and the function of converting an optical signal into an electric signal. In other words, the optical device 10 is at least one of a light emitting device and a light receiving device (or may be a light receiving and emitting device that combines a light emitting device and a light receiving device). The optical device 10 is mounted on a circuit board 40. An optical device active layer is formed on an upper surface of the optical device 10. In this optical device active layer, an electric signal is converted into an optical signal, or an optical signal is converted into an electric signal. In this embodiment, invisible light of a first wavelength is set as light (optical signal) for use in optical communication.

The light transmitting member 20 is made of a synthetic resin that has a property of transmitting light. The light transmitting member 20 has a fitting portion 21 and a lens portion 22. A counterpart optical member can be fitted into the fitting portion 21 is a portion. The fitting portion 21 of this embodiment is a tubular portion into which a substantially cylindrical ferrule 90 can be inserted. An optical fiber 91 is fixed in the center of the cylindrical ferrule 90. A lens portion 92 for converging parallel light or emitting parallel light is formed at an end of the ferrule 90. A leading end surface 211 of the fitting portion 21 into which the above-described cylindrical ferrule 90 can be inserted is ring-shaped, and the central axis of this “ring” coincides with an optical axis X. A step is formed inside the fitting portion 21 and serves as a stopper for the ferrule 90 when the ferrule 90 is inserted inside the fitting portion 21. The circumference of the lens portion 92 of the ferrule 90 comes into contact with the step. An inner bottom surface 24 of the fitting portion 21 constitutes an emitting surface from which light is emitted or an incident surface on which light is incident.

If the optical device 10 is a light emitting device, the lens portion 22 collimates light of the first wavelength emitted from the light emitting device. On the other hand, if the optical device 10 is a light receiving device, the lens portion 22 converges parallel light of the first wavelength emitted from the counterpart optical member into converged light to be incident on the light receiving device. In other words, the lens portion 22 optically connects the optical device 10 to a communication element, such as the optical fiber 91, that is fixed to the counterpart optical member. The lens portion 22 is designed such that light of the first wavelength propagating through the space between the light transmitting member 20 and the counterpart optical member is collimated.

Light is refracted through the lens portion 22. The refractive index of light varies depending on wavelength. Therefore, if the optical module 1 is irradiated with visible light of a wavelength that is shorter than the first wavelength, the light passes through the lens and is reflected by the optical device active layer, and the reflected light is imaged. In this embodiment, the various members are designed such that the position of an imaging plane 11 of the optical device active layer coincides with the position of the leading end surface 211 of the fitting portion 21 in the direction of the optical axis X. The imaging plane 11 is formed when visible light of a second wavelength (between an upper limit wavelength of 760 nm to 830 nm and a lower limit wavelength of 360 nm to 400 nm, more specifically between 360 nm and 830 nm, preferably between 400 nm and 760 nm) that is shorter than the first wavelength is irradiated. In other words, the various members are designed such that the light is imaged on a plane Y shown in FIG. 1. In this embodiment, the first wavelength may be about 850 nm, and the second wavelength may be set at about 450 nm. The second wavelength is set at a wavelength that enables positioning of the optical device 10 and the light transmitting member 20 to be performed, which will be described later.

The light transmitting member includes a tubular portion 23 extending from the fitting portion 21. The light transmitting member 20 and the optical device 10, which is mounted on the board 40, are positioned in a predetermined positional relationship by a leading end of the tubular portion 23 being fixed to the board 40. The method for connecting the tubular portion 23 to the board 40 is not limited to a particular method, but it is preferable to adopt a method that facilitates positioning, which will be described later. In this embodiment, a metal shield member 30 is fixed (e.g., by insert molding) to the inside of the tubular portion 23 of the light transmitting member 20. Board connecting portions 31 provided on this shield member 30 are inserted into through holes 41 of the board 40 and, in this inserted state, are soldered to the through holes 41. In this manner, the light transmitting member 20 is positioned relative to the board 40 and relative positions of the optical device 10, which is mounted on the board 40, and the light transmitting member 20 are set. The through holes 41 are formed to be larger than the outer shapes of the board connecting portions 31. Thus, the board connecting portions 31 can move in a direction that is parallel to the surface of the board 40 within the respective through holes 41 before they are soldered to the through holes 41.

The shield member 30 covers the optical device 10 and a portion of the board 40, except for at least a portion constituting an optical path. The shield member includes an opening 32 that is formed at a portion intersecting the optical axis X. The shield member has an effect of shielding the optical device 10 when the shield member 30 is connected to ground via the board 40.

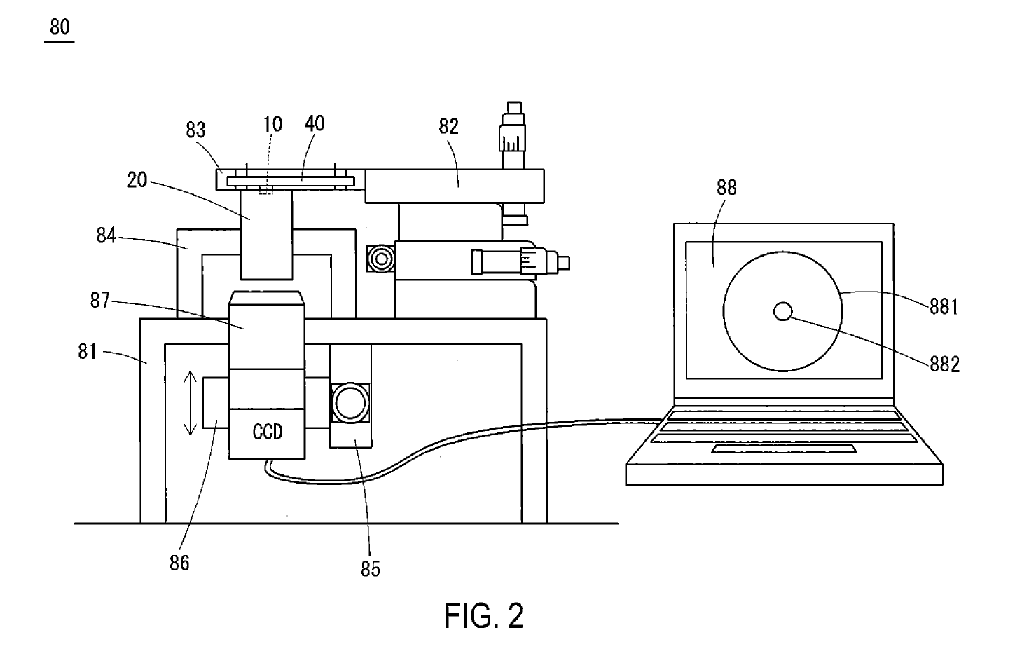

An alignment system 80 used for manufacturing the optical module 1 according to the embodiment of the invention will be described below. As shown in FIG. 2, the alignment system 80 includes a mount 81. A board moving mechanism 82 is provided on the mount 81. The board moving mechanism 82 moves the board 40 that is held by a board holding mechanism 83 in a direction in which the plane of the board 40 extends. The board 40 is held by the board holding mechanism 83 in an orientation in which the board surface of the board 40 is horizontal and the optical device 10 faces downward.

A light transmitting member holding mechanism 84 for holding the light transmitting member 20 is also provided on the mount 81. The light transmitting member 20 is held by the light transmitting member holding mechanism 84 in an orientation in which the fitting portion 21 is located on the lower side and the central axis (optical axis X) of the light transmitting member 20 extends in the vertical direction.

Furthermore, a camera moving mechanism 85 capable of moving the camera 87 that is held by a camera holding mechanism 86 in the vertical direction is provided on the mount 81. The camera moving mechanism 85 is also capable of moving the camera 87 in the horizontal direction. In this embodiment, a CCD camera is used as the camera 87.

The camera 87 is connected to the monitor 88 via a cable. An image that is captured by the camera 87 is displayed on the monitor 88. A first aiming field 881 for use in adjusting the relative positions of the camera 87 and the light transmitting member 20 and a second aiming field 882 for use in adjusting the relative positions of the camera 87 and the optical device active layer (imaging plane 11) are displayed on the monitor 88. The monitor 88 displays the first aiming field 881 and the second aiming field 882. It is also possible to attach a transparent sheet on which the first aiming field 881 and the second aiming field 882 are printed to the monitor 88, thereby creating a state in which the first and second aiming fields 881 and 882 look as if they were shown on the monitor 88.

The first aiming field 881 is formed to have a shape and size that are equal to the shape and size of the outer edge of the leading end surface 211 of the fitting portion 21 of the light transmitting member 20 that is displayed on the monitor 88 when the leading end surface 211 is imaged by the camera 87. Specifically, the first aiming field 881 has a circular shape. The second aiming field 882 has a circular shape that is smaller than that of the first aiming field 881. The second aiming field 882 is concentric with the first aiming field 881.

The method for manufacturing the optical module 1 according to the embodiment of the invention will be described. This manufacturing method includes an alignment step (positioning step) of the optical device 10 and the light transmitting member 20 in which the above-described alignment system 80 is used. The following description gives the details of the alignment step.

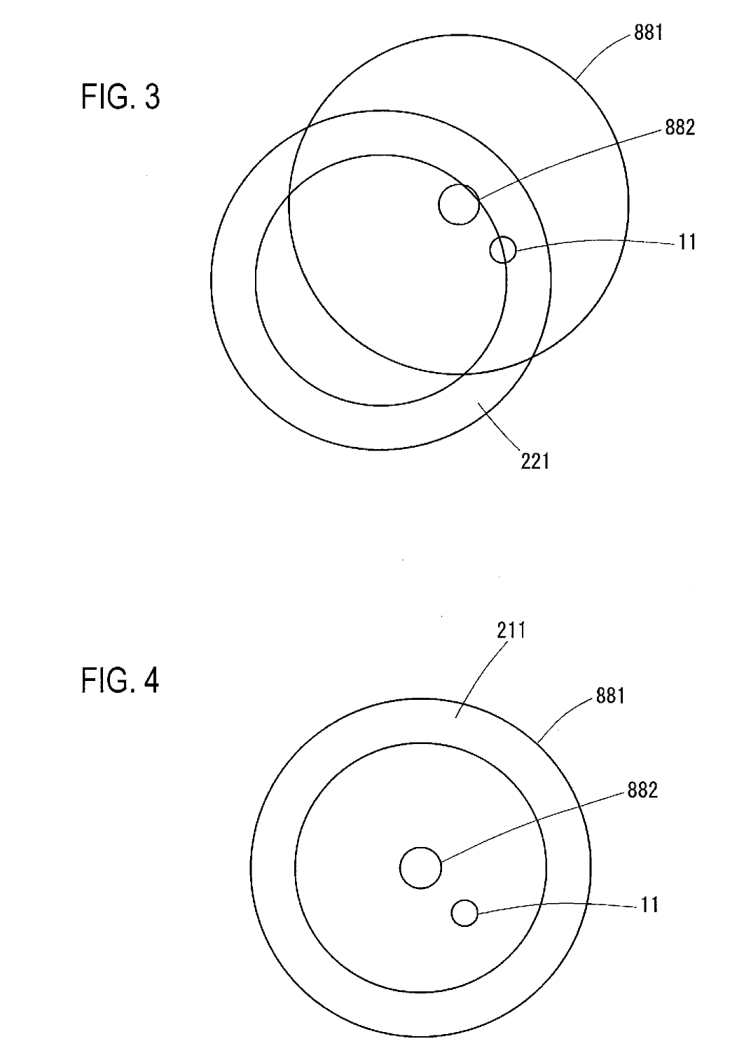

First, in a state in which visible light of the second wavelength is irradiated from a light source, which is not shown, the camera 87 is moved in the vertical direction by the camera moving mechanism 85 so that the camera 87 is focused on a plane Y that is coplanar with the leading end surface 211 of the fitting portion 21. Then, the first aiming field 881, the second aiming field 882, the leading end surface 211 of the fitting portion 21, and the imaging plane 11 of the optical device active layer (the light of the second wavelength passing through the lens, reflected from the optical device active layer, and imaged on the plane Y), are displayed on the monitor 88 (see FIG. 3). In other words, the first aiming field 881 and the second aiming field 882, which serve as the positioning references, and the imaging plane 11 of the optical device active layer and the leading end surface 211 of the fitting portion 21, which are the positioning targets, are clearly displayed on the same screen.

Subsequently, the camera 87 is moved in the horizontal direction by the camera moving mechanism 85 so that the first aiming field 881 and the outer edge of the leading end surface 211 of the fitting portion 21 coincide with each other (see FIG. 4). Thus, the camera 87 and the light transmitting member 20 are positioned relative to each other.

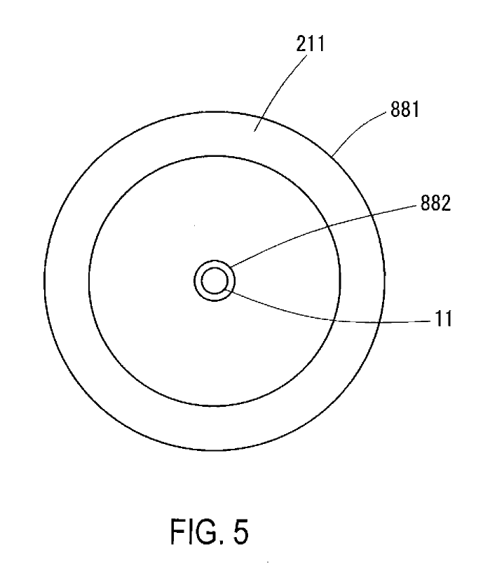

After the camera 87 and the light transmitting member 20 are positioned relative to each other, the board 40 is moved in the horizontal direction by the board moving mechanism 82 to place the imaging plane 11 of the optical device active layer within a region surrounded by the second aiming field 882 (see FIG. 5). Thus, the camera 87 and the optical device active layer are positioned relative to each other. In this embodiment, since the leading end surface 211 of the fitting portion 21 is ring-shaped, the leading end surface 211 and the imaging plane 11 of the optical device active layer are made substantially concentric with each other by this operation. At this stage, relative positioning of the light transmitting member 20 and the optical device active layer (optical device 10) is finished because relative positioning of the camera 87 and the light transmitting member 20 has already been finished.

Finally, in the state in which the positions of the various members are maintained, the board connecting portions 31 of the shield member 30, which is fixed to the light transmitting member 20, are soldered to the through holes 41 of the board 40. Thus, the optical module 1 in which the light transmitting member 20 and the optical device 10 are positioned in a correct predetermined positional relationship is obtained.

Hereinafter, embodiments of the invention will be described by means of specific examples. In a first example, UItem (UItem1010; “UItem” is a registered trademark of SABIC Innovative Plastics IP BV) was used as the light transmitting member 20. With this material, the refractive index of the light transmitting member 20 when the communication wavelength (first wavelength λ1) is set at 850 nm is about 1.64, and the refractive index of the light transmitting member 20 when the wavelength (second wavelength λ2) of the visible light that is irradiated during positioning is set at 450 nm is about 1.70 (both are the refractive indices at 20° C.).

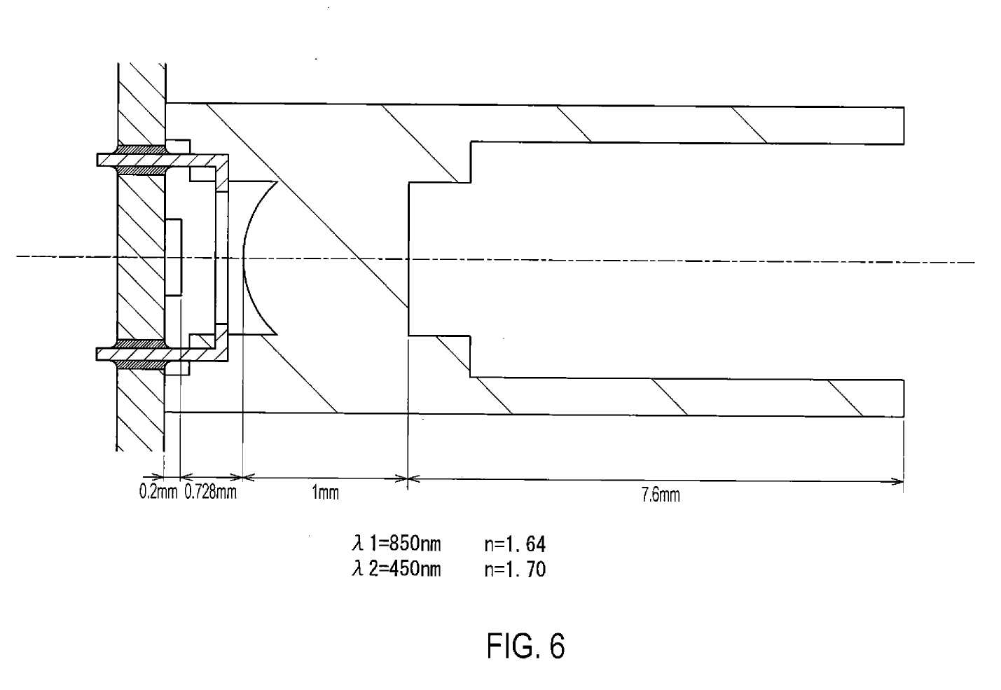

In this case, when the light transmitting member 20 is designed to have such a shape that light of the first wavelength passing through the lens portion 22 is collimated, and when the position of the imaging plane on which light of the second wavelength transmitted through the lens portion 22 and reflected by the optical device 10 is imaged coincides with the position of the leading end surface 211 of the fitting portion 21 in the optical axis X direction, the various members have dimensions as shown in FIG. 6. In FIG. 6, the distance from the lens portion 22 to the emitting surface or the incident surface (base end of the fitting portion 21) is used as the reference (1 mm). The lens parameters are as follows: the radius of curvature: 0.467 mm, the conic: −0.485, and the fourth order coefficient: −2.323.

In a second example, Teralink (a registered trademark of Sumitomo Electric Fine Polymer, Inc.) was used as the light transmitting member 20. With this material, the refractive index of the light transmitting member 20 when the communication wavelength (first wavelength) is set at 850 nm is about 1.51, and the refractive index of the light transmitting member 20 when the wavelength (second wavelength) of the visible light that is irradiated during positioning is set at 450 nm is about 1.57 (both are the refractive indices at 20° C.).

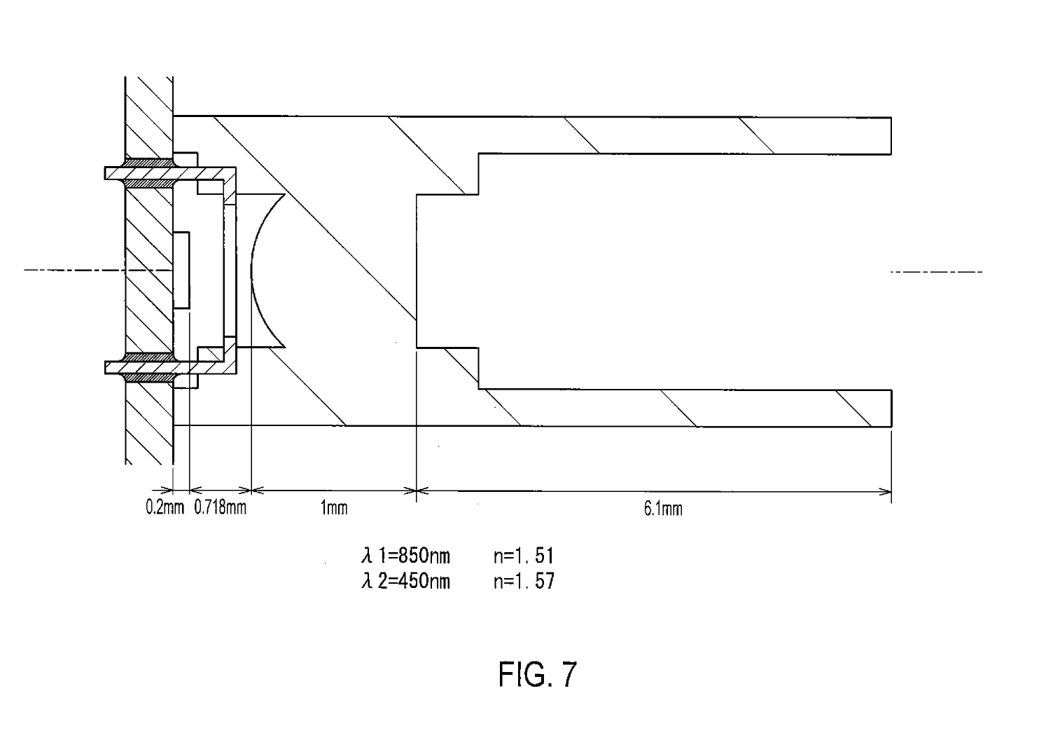

In this case, when the light transmitting member 20 is designed to have such a shape that light of the first wavelength passing through the lens portion 22 is collimated, and when the position of the imaging plane on which light of the second wavelength transmitted through the lens portion 22 and reflected by the optical device 10 is imaged coincides with the position of the leading end surface 211 of the fitting portion 21 in the optical X axis direction, the various members have dimensions as shown in FIG. 7. In FIG. 7, the distance from the lens portion 22 to the emitting surface or the incident surface (base end of the fitting portion 21) is used as the reference (1 mm). The lens parameters are as follows: the radius of curvature: 0.369 mm, the conic: −0.752, and the fourth order coefficient: −3.083.

As described above, the light transmitting member 20 that is designed to have such a shape that light of the first wavelength passing through the lens portion 22 is collimated, and is designed so that the position of the imaging plane on which light of the second wavelength transmitted through the lens portion 22 and reflected by the optical device 10 is imaged coincides with the position of the leading end surface 211 of the fitting portion 21 in the direction of the optical axis X makes it possible to accurately position the optical device 10 and the light transmitting member 20 by using visible light of the second wavelength, even in the case where light of the first wavelength (communication wavelength) passing through the lens portion 22 is collimated.

Although the above-described examples assume that positioning of the optical device 10 and the light transmitting member 20 is performed under ambient temperature conditions of 20° C. (ordinary temperature), the light transmitting member 20 may also be designed on the assumption that positioning is performed below this temperature. The details will be described below.

The refractive index of a light transmissive material increases as the temperature decreases. For example, UItem, which forms the light transmitting member 20 of the first example described above, has a refractive index of about 1.64 at 20° C. and 1.643 at 0° C. When the light transmitting member 20 is designed with the use of these characteristics on the assumption that the ambient temperature is lowered during positioning of the optical device 10 and the light transmitting member 20, the distance from the lens portion 22 to the leading end surface 211 of the fitting portion 21 can be reduced. However, care should be taken because if the ambient temperature is excessively lowered, condensation forms on the light transmitting member 20. However, if the humidity is controlled so as to prevent the formation of condensation, the ambient temperature can be significantly decreased, and the refractive index can be increased.

Although an embodiment of the invention has been described in detail above, the invention is not limited to the above-described embodiment, and various modifications are possible without departing from the scope of the invention.

What is claimed is:

1. An optical module comprising:
an optical device;
a light transmitting member made of a light transmissive material, the light transmitting member having a fitting portion into which a counterpart optical member is fitted and a lens portion that collimates light of a first wavelength emitted from the optical device or converges parallel light of the first wavelength emitted from the counterpart optical member into converged light to be incident on the optical device, wherein
the light transmitting member is formed in such a shape that when visible light is irradiated, a position of an imaging plane coincides with a position of a leading end surface of the fitting portion in a direction of the optical axis,
the visible light is of a second wavelength that is lower than the first wavelength, and
the imaging plane is defined by a plane on which the visible light transmitted through the lens portion and reflected by the optical device is imaged.

2. The optical module according to claim 1,
wherein the leading end surface of the fitting portion has a ring shape, the center of the ring shape being located on the optical axis.

3. A method for manufacturing the optical module according to claim 1, the method comprising a positioning step,
wherein the positioning step comprises:
irradiating the optical device and the light transmitting member with the visible light; and
positioning the optical device relative to the light transmitting member such that the optical device is in a position at which relative positions of the imaging plane and the leading end surface of the fitting portion satisfy a predetermined positional relationship by moving at least one of the optical device and the light transmitting member while observing the relative positions of the imaging plane and the leading end surface of the fitting portion using an imaging apparatus.

4. A method for manufacturing the optical module according to claim 2, the method comprising a positioning step,
wherein the positioning step comprises:
irradiating the optical device and the light transmitting member with the visible light; and
positioning the optical device relative to the light transmitting member such that the leading end surface of the fitting portion and the imaging plane are concentric by moving at least one of the optical device and the light transmitting member while observing relative positions of the imaging plane and the leading end surface of the fitting portion using an imaging apparatus.
